(19) United States
(12) Patent Application Publication
(10) Pub. No.: US 2004/0111835 A1
(43) Pub. Date: Jun. 17, 2004

(54) Mounting and securing a bar

(76) Inventor: Hubert Elmer, Innsbruck (AT)

Correspondence Address: COHEN, PONTANI, LIEBERMAN & PAVANE, 551 FIFTH AVENUE, SUITE 1210, NEW YORK, NY, 10176, US

(21) Appl. No.: 10/473,755

(22) PCT Filed: Apr. 23, 2002
(86) PCT No.: PCT/EP02/04452

(30) Foreign Application Priority Data
Apr. 23, 2001 (DE) 101 19 986-4

(51) Int. Cl. E05D 1/00

(52) U.S. Cl. 16/221

(57) ABSTRACT

The present invention is directed to a pivot bearing (1) for pivoting doors (2) with a holding part (7) and a bearing shaft (4) which has an area (5) provided with a thread and a bearing area (6) for supporting a pivot bar (22) of the pivoting door (2). Further, there is a connection part (10) which connects the holding part (7) to the bearing shaft (4). The connection part (10) has a slot (11) formed parallel to an axis of rotation (X-X), a pin (16) fastened in the bearing shaft (4) being guided in this slot (11). An adjusting device (14) is screwed onto the threaded area (5) of the bearing shaft (4) and enables an axial positioning of the bearing shaft (4).

The present invention is directed to a bearing support and fastening of a pivot bearing for revolving or pivoting doors and particularly for furniture.

Pivot bearings in furniture are known, for example, as hinges. However, hinges are disadvantageous in that they are visible from the outside and, therefore, furniture with pivoting doors that are mounted in this manner can only satisfy aesthetic requirements to a limited extent.

An axially adjustable pivot fitting for shower dividers is known from DE 42 18 175 C1. Its pivot pin is clamped in a receptacle in the corresponding position by a plate serving as an abutment. The axial positioning of the pivot pin is extremely complicated with regard to mounting technique. Further, the clamping screw connection of the plate can loosen automatically due to movements of the shower divider resulting from operation.

Therefore, it is the object of the present invention to provide a bearing support and fastening of a pivot bearing for pivoting doors which is adjustable and constructed in a simple manner, does not show any fastening elements and can be produced economically. Further, the bearing support and fastening according to the invention convey an aesthetically pleasing impression and are used in particular in furniture inside the body.

This object is met by a bearing support and fastening of a pivot bearing having the characteristic features of the main claim. The subclaims show advantageous further developments.

For the sake of clarity, the following description is directed to only one pivot bearing, which also includes the fastening. The pivot bearing, according to the invention, for pivoting doors comprises a bearing shaft, a holding part, a connection part, and an adjusting device. The bearing shaft has an area provided with a thread and a bearing area for a pivot bar of the pivoting door. The holding part is constructed so as to be stationary and is fastened, for example, inside a furniture body, so as to be fixed with respect to rotation. This can be achieved in many different ways, e.g., by means of devices penetrating into the furniture body (e.g., pins, projections, points, etc.). The connection part connects the holding part to the bearing shaft. For this purpose, the connection part has a slot which is formed parallel to the axis of rotation of the pivot bearing and pivoting door. The connection part can be fixed in the holding part and connected to the bearing shaft by a pin arranged in the slot. The adjusting device has an internal thread and can be screwed to the threaded area of the bearing shaft in this way. An axial position of the bearing shaft can be changed relative to the holding part by means of the adjusting device. Consequently, it is possible by means of the pivot bearing according to the invention to displace the bearing shaft provided for supporting the pivot bar of the pivoting door in axial direction, i.e., in the direction of the axis of rotation. Accordingly, it is possible to install the pivot bar between two walls without having to introduce through-holes and bearing devices from the outer sides of the walls. According to the invention, the bearing shaft is positioned by means of the adjusting device completely within a receiving area of the holding part and after the pivot bar of the pivoting door is positioned between the holding parts the bearing shaft is moved in the direction of the axis of rotation by means of the adjusting device so that it can support the pivot bar.

Pivot bearings of this kind are preferably provided at both ends of the pivot bar. The pivot bar is supported at the bearing area of the bearing shaft. According to the invention, the pivot bearing can accordingly be fastened initially in a wall of a piece of furniture and the pivoting door can then be arranged so as to be fixed on the axis of rotation by means of the adjusting device. An especially simple and fast mounting is made possible in this way.

It should be noted that by pivoting door is meant, according to the invention, a door which is swivelable around a shaft or axis. The door can be arranged horizontally as well as vertically (for example, on a bureau). It is possible for the pivot bar to rotate in its entirety or, given suitable fitting parts, the pivot bar can also be fixed. In this construction the fitting parts rotate on the pivot bar.

A fixing device of the adjusting device is preferably formed at the bearing shaft so that the mounted pivot bearing can also maintain its predetermined position during use. The fixing device is realized in a particularly preferred manner by means of a stud screw.

A flange is advantageously formed at the connection part for connecting the holding part to the bearing shaft. The flange can accordingly serve as a stop so that it can be arranged at an outer area of the holding part.

The connection part is preferably fixed to the holding part to enable a predetermined positioning of the two parts relative to one another. Fixing is preferably carried out by means of a stud screw which engages in an annular groove in the connection part.

According to another preferred embodiment example of the present invention, the pivot bearing has a cover with a flange which is arranged between the pivot bearing and the pivot bar of the pivoting door. The flange contacts the pivot bearing and prevents penetration of dirt and dust and the like. This ensures good operation even in dusty areas.

The holding part is advantageously constructed in the manner of a bushing. For this purpose it is particularly preferred that it has the same diameter as the pivot bar. This results in a particularly attractive bearing support of a pivoting door because the holding part forms a visible lengthening of the pivot bar and the bearing support of the pivoting door accordingly appears to the observer as a simply constructed cylindrical rod.

According to another preferred embodiment example of the present invention, a press fit is formed between the bearing shaft and the pivot bar, or the pivot bar is clamped between two pivot bearings in such a way that it can no longer rotate. In this way it is possible for the pivot bar to be fixed between two pivot bearings so that it can no longer rotate. The pivoting doors are therefore prevented from opening accidentally, for example, when transporting furniture. Further, this makes it possible for a bar to be clamped between two walls in horizontal direction, for example, in a closet or cabinet. The bearing according to the invention is accordingly suitable not only for the support of pivoting doors but also for positioning a bar or the like between two bearings in a fixed manner.

It is particularly preferable that the pivot bearing according to the invention is used in furniture having glass doors as pivoting doors in particular. In this way it is possible that the axis of rotation of the pivoting doors of the furniture is relocated into the piece of furniture, so that the pivoting door can terminate flush with the furniture body in the outside area of the furniture without projecting hinges or the like. An internal fulcrum can accordingly be realized according to the invention, this fulcrum being situated in the pivot bearing.

The pivot bearing according to the invention is preferably made from metal, particularly stainless steel.

The invention will be described in more detail in the following with reference to embodiment examples shown schematically.

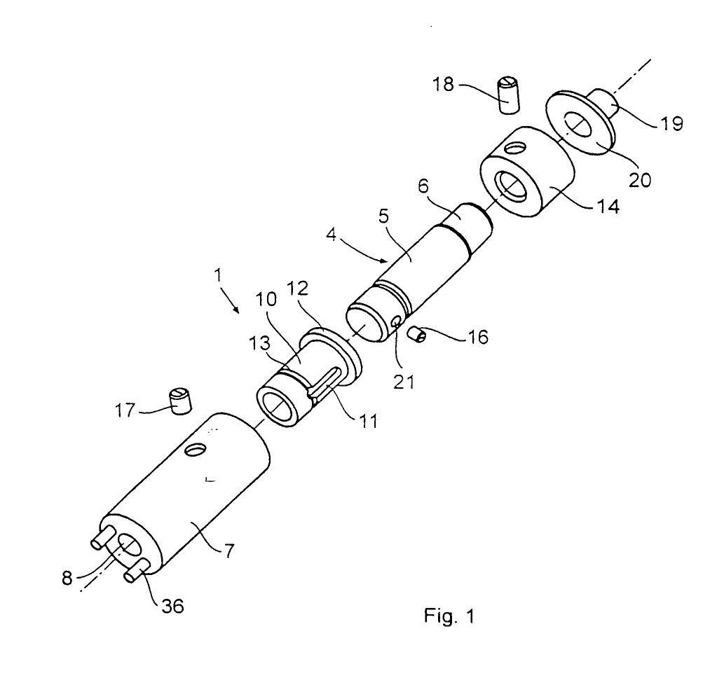

FIG. 1 shows a perspective, exploded view of a pivot bearing according to a first embodiment example of the present invention;

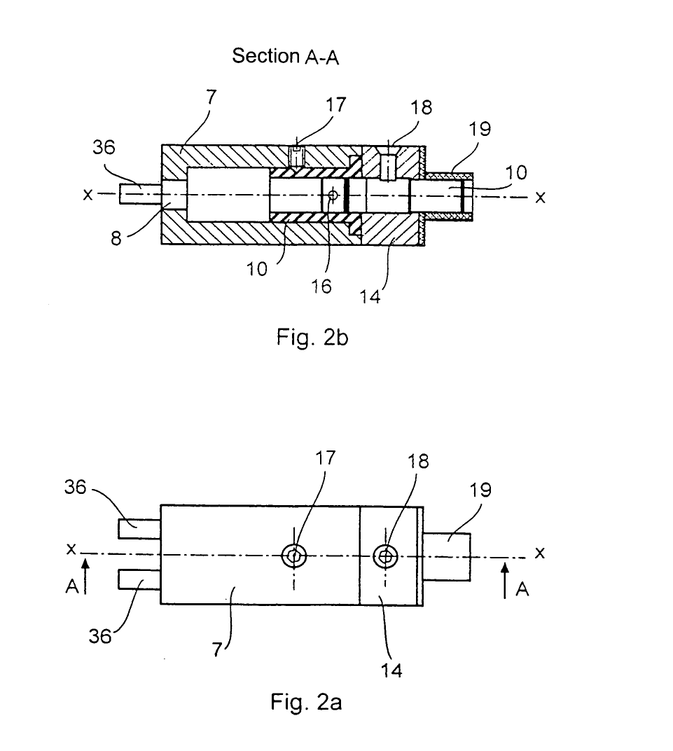

FIGS. 2a and 2b show different views of the pivot bearing according to the first embodiment example of the invention;

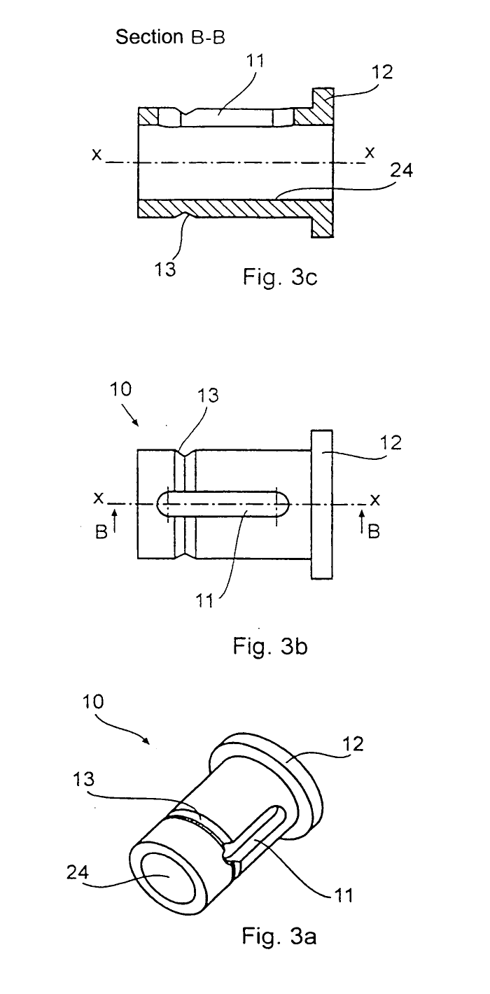

FIGS. 3a to 3c show different views of a connection part according to the first embodiment example of the present invention;

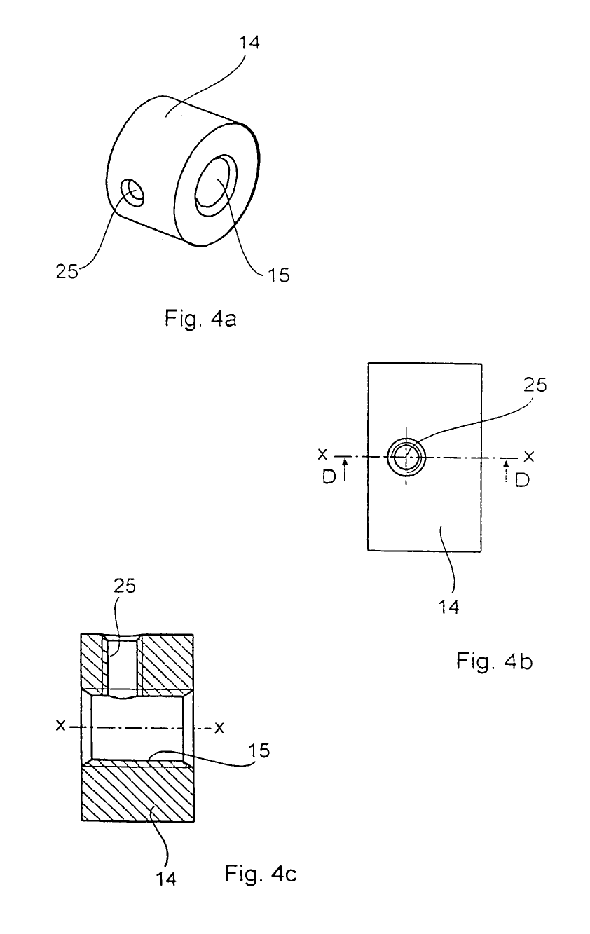

FIGS. 4a to 4c show various views of an adjusting device according to a first embodiment example of the present invention;

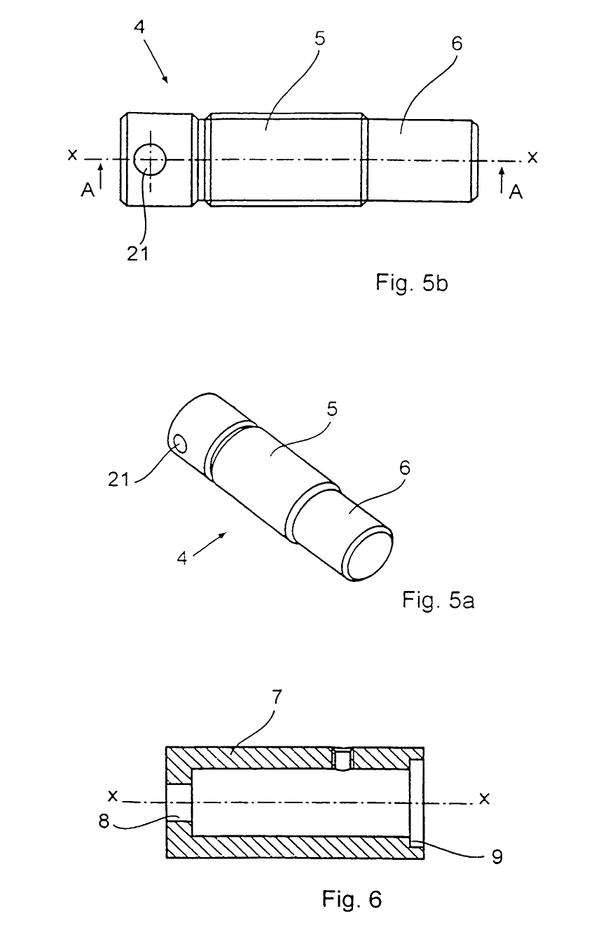

FIGS. 5a and 5b show the different views of a bearing shaft according to the first embodiment example of the present invention;

FIG. 6 shows a sectional view of a holding part according to the first embodiment example of the present invention;

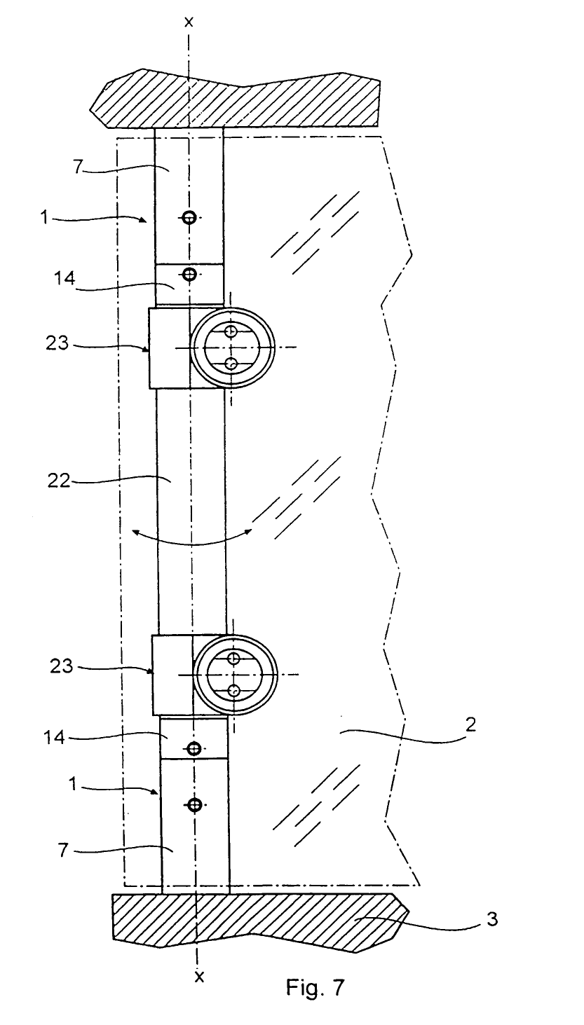

FIG. 7 shows a side view of two mounted pivot bearings, according to the first embodiment example, in a furniture body;

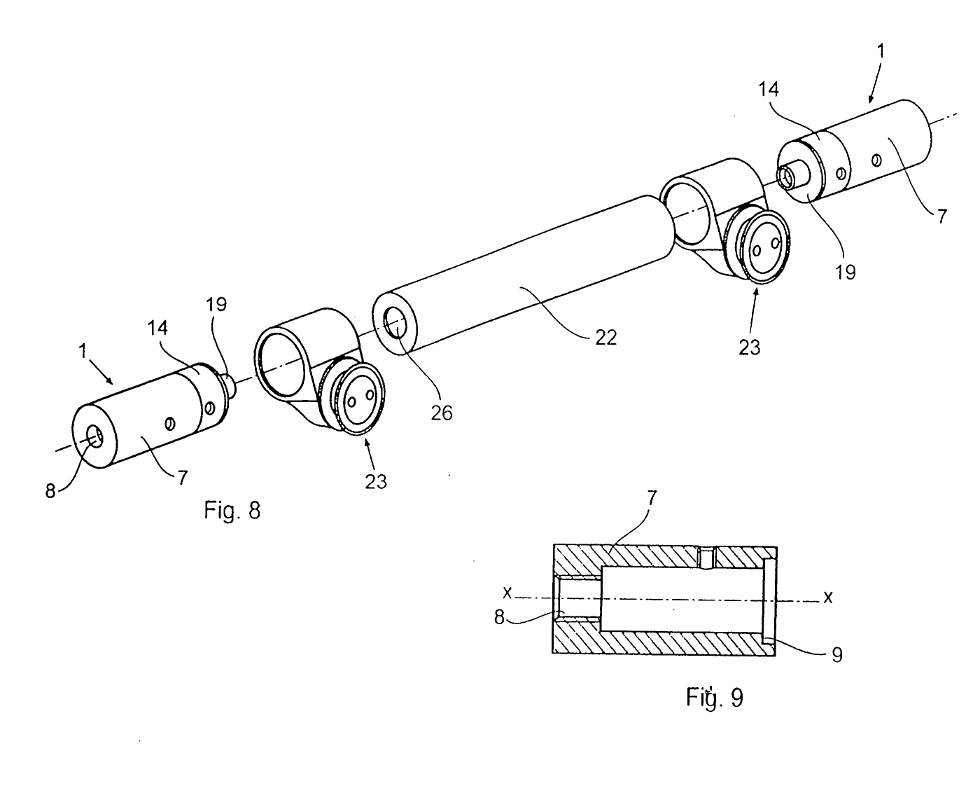

FIG. 8 shows a perspective, exploded view of the pivot bearing shown in FIG. 7, including the pivot bar of the pivoting door; and

FIG. 9 is a sectional view of a holding part according to a second embodiment example of the present invention;

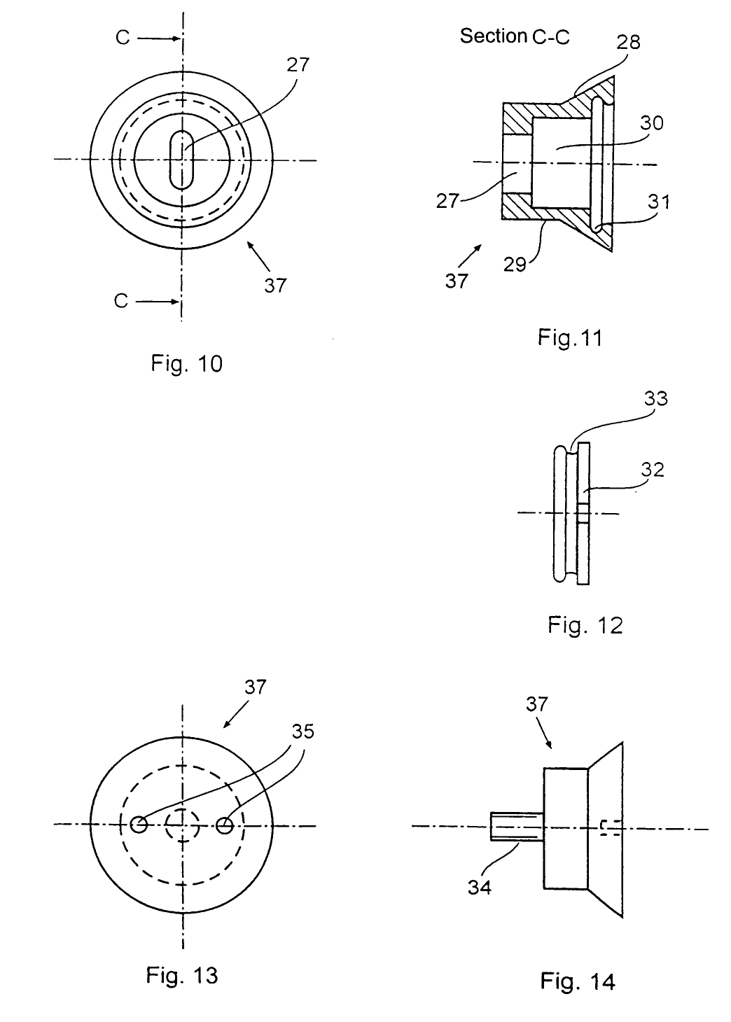

FIG. 10 shows a front view of a fastening element;

FIG. 11 shows a side view of a fastening element;

FIG. 12 shows a closure cap;

FIG. 13 shows a second construction of a fastening element in a front view; and

FIG. 14 shows a view similar to FIG. 13, but in a side view.

A pivot bearing 1 according to a first embodiment example of the present invention will be described in the following with reference to FIGS. 1 to 8.

As is shown in FIG. 1, the pivot bearing 1 comprises a bearing shaft 4, a holding part 7, a connection part 10, and an adjusting device 14. The holding part 7 has a stepped through-hole (see FIG. 6) in which the connection part 10 is arranged (see FIG. 2b). A bore hole 8 is provided so that the holding part 7 is fastened, for example, in a furniture body 3, e.g., by means of a screw. Pins are arranged at the underside to prevent rotation of the holding part 7 in the furniture body 3, for example.

The connection part 10 is shown in more detail in FIGS. 3a to 3c. The connection part 10 is formed as a sleeve and has a slot 11, an annular groove 13 and a flange 12. The flange 12 is arranged in a cutout 9 of the holding part 7 in the mounted state. The holding part 7 and the connection part 10 are connected to one another in the area of the annular groove 13 by a stud screw 17 (see FIG. 2b). The connection part 10 is connected to the bearing shaft 4 by a pin 16 which projects into the slot 11. This makes it possible for the bearing shaft 4 to move in axial direction X-X, wherein the pin 16 is guided into the slot 11. A movement of the bearing shaft 4 in circumferential direction relative to the connection part is prevented by the slot 11. The pin 16 is fastened in the bearing shaft, for example, by means of a press fit and projects out of the bearing shaft 4 far enough so that it can be securely guided into the slot 11.

The bearing shaft 4 is shown in more detail in FIGS. 5a and 5b. As can be seen in particular from FIG. 5b, the bearing shaft 4 has a threaded area 5 and a bearing area 6. Further, a bore hole 21 is arranged at an end area of the bearing shaft for receiving the pin 16. The threaded area 5 is located between this end area and the bearing area 6.

The adjusting device 14 is shown in more detail in FIGS. 4a to 4c. The adjusting device 14 is formed as a nut, but has a cylindrical outer circumference. The adjusting device 14 is provided with a through-hole having an internal thread 15 and has a radial bore hole 25 which serves to receive a stud screw 18 (see FIG. 2b). A desired position of the bearing shaft 4 can be fixed in the adjusting device 14 by means of the stud screw 18.

The mounting and the operation of the pivot bearing 1 according to the first embodiment example will be described in the following. For mounting, the bearing shaft 4 is first inserted into the connection part 10 and the bore hole 21 of the bearing shaft 4 is aligned with the slot 11 of the connection part 10. Subsequently, the pin 16 is inserted through the slot 11 into the bore hole 21 of the bearing shaft 4. Since the pin is inserted in such a way that it projects out of the bearing shaft 4 into the slot 11, the bearing shaft 4 and the connection part 10 are now connected to one another in such a way that the bearing shaft 4 can move in axial direction X-X, wherein it is guided in the slot 11. Its movement in axial direction X-X is limited in that the pin 16 strikes the respective ends of the slot 11. The adjusting device 14 is subsequently screwed to the threaded area 5 of the bearing shaft 4. The connection part 10 is then introduced into the stepped bore hole of the holding part 7 and is fixed by means of the stud screw 17 (see FIG. 2). A cover 19 with a flange 20 is then slid over the bearing area 6 of the bearing shaft 4. This permanently fixes the pivot bearing 1. By rotating at the adjusting device, the axial position of the bearing shaft 4 can be changed in the direction of the axis of rotation X-X, since the bearing shaft 4 is prevented from rotating by the pin 16 arranged in the slot 11. The rotating movement is accordingly transformed into a longitudinal movement in the direction of the axis of rotation X-X.

It should be noted that the cover 19 is not absolutely required for the operation of the pivot bearing. However, the cover 19 does prevent dust and dirt from entering the threaded areas of the pivot bearing 1.

When the desired axial position of the bearing shaft 4 is adjusted by means of the adjusting device 14, this position can be fixed by the stud screw 18. The bearing area 6 of the bearing shaft 4 and the cover 19 can therefore receive a pivot bar 22 of a pivoting door 2 which has about the same dimensions in its longitudinal extension as the inner dimensions of a furniture body. This is shown in FIGS. 7 and 8. The pivot bar 22 has a bearing area 26 which is formed as a cylindrical bore hole at its two ends (see FIG. 8). The bearing area 26 of the pivot bar 22 of the pivoting door 2 is constructed in such a way that it can receive the bearing area 6 of the bearing shaft 4 and can rotate about the axis of rotation X-X. The bearing shaft 4 is held so as to be stationary by the pin 16 in the slot 11. As is shown in FIG. 7, the pivoting door 2 is fastened to the pivot bar 22 by means of fastening devices 23, wherein the pivoting door 2 is made of glass, and fittings (fastening device 23) which terminate flush with the surface of the pivoting door 2 on the outside are used inside the stepped bore hole.

The embodiment example shown in FIG. 7 can depict a glass door (pivoting door 2), for example, which is supported inside a furniture body 3 by the pivot bar 22 with the holding parts 7. The pivoting door 2 is fitted by means of fittings in the form of fastening devices 23 which terminate in a punctiform manner with the glass surface on the outside so as to be flush. Two fastening devices 23 are presented in the embodiment examples of FIGS. 10, 11 and 13, 14. This is a holding element 37 which is countersunk in a stepped bore hole introduced into the pane of glass 2. The bore hole has a conical shape which passes into a cylindrical shape. Therefore, the holding element 37 likewise has a complementary shape which has a cylindrical shoulder or projection 29 with an adjoining conical projection 28.

The embodiment example of the holding element in FIGS. 10 and 11 is constructed in such a way that a pocket hole 30 is located inside the holding element 37, a through-hole in the form of an elongated hole 27 being provided at its base. A fastening element in the form of a screw is screwed together with the fastening device 23 through the elongated hole 27. The pane of glass which is clamped in by the holding element 37 and possibly by an intermediate layer in the form of protective glass is accordingly fastened to the pivot bar 22. The head of the connection screw lies in the pocket hole 30. The holding element 37 is closed by a closure cap 32. For this purpose, the closure cap 32 preferably has an annular groove 33 in which is inserted a circumferentially extending annular spring, not shown, which produces a pretensioning with an undercut 31 inside the holding element 37 when inserted into the holding element 37. It is possible to adjust the holding element 37 through the elongated hole 27.

A modified holding element 37 is shown in FIGS. 13 and 14. This holding element is constructed as a whole piece and has, at the cylindrical projection 29, a threaded projection 34 which is screwed into the fastening device 23. In order to screw in the holding element 37, recesses 35 are provided on the front side and allow the use of a suitable tool for fastening the pane of glass.

It is understood that apart from the construction of a glass pivoting door 2 described above, any other plate-shaped material such as wood, plastic or metal can also be used. When mounting a pivoting door 2 on a piece of furniture 3 as is shown in FIG. 7, the pivot bar 22 is supported between two pivot bearings 1 on the top and the bottom. The piece of furniture 3 is mounted in such a way that the two holding parts 7 are initially fastened in the furniture body 3 by means of screws. The pivot bearing 1 is subsequently completed, wherein the bearing shaft 4 is positioned in the holding part 7 by means of the adjusting device 14 in such a way that the bearing area does not project out of the adjusting device 14. Subsequently, the pivot bar 22 at which the pivoting door 2 is fastened by means of the fastening devices 23 is positioned between the two pivot bearings. The bearing shaft 4 of the pivot bearing is then positioned by means of the adjusting device in such a way that the bearing area 6 of the bearing shaft 4 projects out of the pivot bearing 1 and extends into the bearing area 26 of the pivot bar 22. The pivot bar 22 is accordingly securely supported on bearings and enables a rotation of the pivoting door 2 with continuously adjustable play.

When a rotation of the pivoting door 2 is not desired, for example, for transporting, the bearing area 6 of the bearing shaft 4 can be rotated out of the pivot bearing 1 by means of the adjusting device 14 until the pivot bar 22 is clamped. This prevents rotation of the pivot bar 22 and therefore prevents the pivoting door from opening when transported. When transporting is concluded, the bearing shaft 4 can be rotated back in axial direction X-X in a simple manner by means of the adjusting device 14 until the pivoting door 2 can be swiveled around the axis of rotation X-X again.

It is noted that, for example, a clothing bar can also be fastened in a clothes closet or the like by means of the bearing device according to the invention.

According to the invention, it is also possible in particular to fasten pivoting doors for furniture to the furniture in such a way that the fastening of the pivot bearing is carried out only from the inner side of the furniture in an invisible manner without screws or other fasteners being visible from the outer side of the furniture. A pivoting door 2 for furniture can be arranged in such a way that it terminates flush with the piece of furniture. The pivot bearing 1 according to the invention is constructed in a very simple manner and also functions as a device for securing during transport. Further, a desired resistance can be adjusted when opening the pivoting doors 2 (difficult or easy opening) by adjusting a deliberate amount of friction between the bearing area 6 of the bearing shaft 4 and the bearing area 26 of the pivot bar 22.

As is shown particularly in FIGS. 7 and 8, the pivot bearing according to the invention can be constructed in such a way that the bearing support of the pivoting door 2 is not immediately visually detectable for an observer because the pivot bearing 1 and the pivot bar 22 have the same outer diameter. This results in a particularly appealing design of the pivot bearing and pivoting doors which can be used in combination with glass doors particularly for furniture.

FIG. 9 shows a holding part 7 according to a second embodiment example of the present invention. Identical parts are designated by the same reference numbers as in the first embodiment example.

In contrast to the first embodiment example, the stepped bore hole in the holding part of the second embodiment example is provided at the end having a thread 8′. Accordingly, it is not only possible to fasten the holding part 7 from the inside, but a screw can also be guided from the outside, e.g., through a wall of a piece of furniture. In other respects, the construction of the holding part 7 according to the second embodiment example corresponds to that of the first embodiment example, and reference is had to that description.

Therefore, the present invention is directed to a pivot bearing 1 for pivoting doors 2 with a holding part 7 and a bearing shaft 4 which has an area 5 provided with a thread and a bearing area 6 for supporting a pivot bar 22 of the pivoting door 2. Further, a connection part 10 is provided which joins the holding part 7 to the bearing shaft 4. The connection part 10 has a slot 11 which is constructed parallel to an axis of rotation X-X and in which a pin 16 fastened in the bearing shaft 4 is guided. An adjusting device 14 is screwed to the threaded area 5 of the bearing shaft 4 and makes it possible to position the bearing shaft 4 axially.

The preceding description of the embodiment examples according to the present invention serves for illustration only and not to limit the invention. Various changes and modifications are possible within the framework of the invention without departing from the framework of the invention and its equivalents.

Reference Numbers

1 pivot bearing

2 pivoting door

3 furniture

4 bearing shaft

5 threaded area

6 bearing area

7 holding part

8 bore hole

8′ bore hole with thread

0 cutout

10 connection part

11 slot

12 flange

13 annular groove

14 adjusting device

15 internal thread

16 pin

17 stud screw

18 stud screw

19 cover

20 flange

21 bore hole

22 pivot bar

23 fastening device

24 through-hole

25 bore hole

26 bearing area

27 elongated hole

28 conical projection

29 cylindrical projection

30 pocket hole

31 undercut

32 closure cap

33 annular groove

34 threaded projection

35 recesses

36 means for preventing rotation

37 holding element

1. Bearing support and fastening of a pivot bearing for pivoting doors (2) with an internal fulcrum, particularly for furniture (3), comprising a bearing shaft (4) having a threaded area (5) and a bearing area (6) for supporting a pivot bar (22) of the pivoting door (2), a holding part (7) with means for preventing rotation (36), a connection part (10) which connects the holding part (7) to the bearing shaft (4) and which has a slot (11) formed parallel to the internal axis of rotation (X-X), wherein the connection part (10) can be fixed in the holding part (7) and is connected by a pin (16) which is fastened in the bearing shaft (4) and arranged in the slot (11), and an adjusting device (14) with an internal thread (15) which is screwed onto the threaded area (5) of the bearing shaft (4) and makes it possible to position the bearing shaft (4) in axial direction of the axis of rotation (X-X).

2. Bearing support and fastening according to claim 1, characterized in that the adjusting device (14) can be fixed at the bearing shaft (4).

3. Bearing support and fastening according to claim 2, characterized in that the adjusting device (14) is fixed at the bearing shaft (4) by means of a stud screw (18).

4. Bearing support and fastening according to one of claims 1 to 3, characterized in that the connection part (10) is formed as a bushing and a flange (12) is formed at the connection part (10).

5. Bearing support and fastening according to one of claims 1 to 4, characterized in that the connection part (10) can be fixed at the holding part (7).

6. Bearing support and fastening according to claim 5, characterized in that the connection part (10) is fixed at the holding part (7) by means of a stud screw (17) which engages in an annular groove (13) of the connection part (10).

7. Bearing support and fastening according to one of claims 1 to 6, characterized by a cover (19) which has a flange (20).

8. Bearing support and fastening according to one of claims 1 to 7, characterized in that the holding part (7) is formed as a bushing.

9. Bearing support and fastening according to one of claims 1 to 8, characterized in that a stepped through-hole is provided in the holding part (7) for fastening the holding part.

10. Bearing support and fastening according to one of claims 1 to 9, characterized in that the holding part (7), the adjusting device (14) and the pivot bar (22) have the same outer diameter.

11. Bearing support and fastening according to one of claims 1 to 10, characterized in that the pivot bar (22) can be clamped in a detachable manner by the pivot bearing (1).

12. Bearing support and fastening according to one of claims 1 to 10, characterized in that the pivot bearing (1) is countersunk in a wall (furniture body (3)).

13. Bearing support and fastening according to one of the preceding claims, characterized in that fastening devices (23) are provided at the pivot bar (22).

14. Bearing support and fastening according to claim 13, characterized in that the fastening device (23) has a holding element (37) with a cylindrical projection (29) which passes into a conical projection (28) with a larger diameter.

15. Bearing support and fastening according to claim 14, characterized in that the holding element (37) has a pocket hole (30) whose opening is closed by a closure cap (32).

16. Bearing support and fastening according to claim 15, characterized in that there is an annular groove (33) in which is inserted an annular spring which engages in an undercut (31) of the pocket hole (30).

17. Bearing support and fastening according to one of the preceding claims, characterized in that a threaded projection (34) is provided at the holding element (37).

18. Bearing support and fastening according to one of the preceding claims, characterized in that a continuous elongated hole is provided adjoining the pocket hole (30) for fastening and aligning the holding element (37).

19. Bearing support and fastening according to the preceding claims, characterized in that the pivot bearing (1), the pivot bar (22), the adjusting device (14) and the fastening device (23) are made of stainless steel or brass or light alloy.
